(19) United States
(12) Patent Application Publication
(10) Pub. No.: US 2026/0142330 A1
(43) Pub. Date: May 21, 2026

(54) SEPARATOR FOR RECHARGEABLE BATTERY AND RECHARGEABLE BATTERY INCLUDING THE SAME

(71) Applicant: SAMSUNG SDI CO., LTD., Yongin-si (KR)

(72) Inventors: Chan Kyu LEE, Suwon-si (KR); Hyeon Seon CHOI, Suwon-si (KR); Jung Ran LEE, Suwon-si (KR); Jae Yeon LEE, Suwon-si (KR)

(73) Assignee: SAMSUNG SDI CO., LTD., Yongin-si (KR)

(21) Appl. No.: 19/389,125

(22) Filed: Nov. 14, 2025

(30) Foreign Application Priority Data
Nov. 16, 2024 (KR) 10-2024-0163681

(51) Int. Cl. H01M 50/446; H01M 10/0525; H01M 50/42; H01M 50/426; H01M 50/451; H01M 50/46; H01M 50/491; H01M 50/497

(52) U.S. Cl. CPC H01M 50/446; H01M 10/0525; H01M 50/42; H01M 50/426; H01M 50/451; H01M 50/461; H01M 50/491; H01M 50/497

(57) ABSTRACT

The present disclosure relates to a separator for a rechargeable battery and a rechargeable battery including the separator. The separator includes a porous substrate and a coating layer located on at least one surface of the porous substrate. The coating layer includes a crosslinked product of a binder and a crosslinking agent, and a filler. The binder includes a (meth)acrylic binder including a first structural unit derived from (meth)acrylic acid, (meth)acrylate, or a salt thereof, a second structural unit derived from hydroxyalkyl (meth)acrylate, and a third structural unit derived from (meth)acrylamido sulfonic acid or a salt thereof. The crosslinking agent includes an aziridine-based crosslinking agent. The filler includes a mixture of a first filler and a second filler, wherein the first filler is an inorganic filler and the second filler is a metal-organic framework structure.

### CROSS-REFERENCE TO RELATED APPLICATION

The present application claims priority to Korean Patent Application No. 10-2024-0163681, filed on Nov. 16, 2024 in the Korean Intellectual Property Office, the entire disclosure of which is incorporated herein by reference.

### BACKGROUND

### 1. Field of the Disclosure

The present disclosure relates to a separator for a rechargeable battery, and a rechargeable battery including the separator.

### 2. Discussion of Related Art

With increasing presence of electronic devices such as, e.g., mobile phones, notebook computers, electric vehicles, and the like, that use batteries, the demand for secondary batteries having high energy density and high capacity is increasing. Therefore, improving the performance of rechargeable lithium batteries may be advantageous.

A rechargeable lithium battery includes a positive electrode and a negative electrode that contain an active material capable of the intercalation and deintercalation of lithium ions, and produces electric energy by oxidation and reduction reactions when the lithium ions are intercalated into and deintercalated from the positive electrode and the negative electrode.

A rechargeable lithium battery may include a separator between the positive and negative electrodes. The separator is impregnated with an electrolyte and is bonded to the positive or negative electrode.

### SUMMARY

One example embodiment includes a separator for a rechargeable battery which provides a low thermal shrinkage rate, high rate characteristics during charging and discharging, low membrane resistance, and high adhesion to an electrode plate.

Another example embodiment includes a rechargeable battery including the separator for a rechargeable battery.

One example embodiment includes a separator for a rechargeable battery.

The separator for a rechargeable battery includes: a porous substrate; a first coating layer and a first adhesive layer located, e.g., sequentially located, on a first surface of the porous substrate; and a second coating layer and a second adhesive layer located, e.g., sequentially located, on a second surface of the porous substrate, wherein each of the first coating layer and the second coating layer includes a crosslinked product of a binder and a crosslinking agent, and a filler. The binder includes a (meth)acrylic binder including a first structural unit derived from (meth)acrylic acid, (meth)acrylate, or a salt thereof, a second structural unit derived from hydroxyalkyl (meth)acrylate, and a third structural unit derived from (meth)acrylamido sulfonic acid or a salt thereof. The crosslinking agent includes an aziridine-based crosslinking agent, the filler includes a mixture of a first filler and a second filler, wherein the first filler is an inorganic filler and the second filler is a metal-organic framework structure. The first adhesive layer includes a (meth)acrylic based adhesive binder, and the second adhesive layer includes a fluorine-based adhesive binder having a carbonyl group (C═O).

Another example embodiment includes a rechargeable battery.

The rechargeable battery includes a positive electrode, a negative electrode, and the above-described separator located between the positive electrode and the negative electrode.

### BRIEF DESCRIPTION OF THE DRAWINGS

The above and other objects, features and advantages of the present disclosure may become more apparent to those of ordinary skill in the art by describing example embodiments thereof in detail with reference to the accompanying drawings, in which:

FIG. 1 is a cross-sectional view showing a separator for a rechargeable lithium battery according to one example embodiment; and

FIG. 2 to FIG. 5 are cross-sectional views schematically showing rechargeable lithium batteries according to example embodiments.

### DETAILED DESCRIPTION

Hereinafter, example embodiments of the present disclosure are described in detail. However, the embodiments are presented as examples, and the present disclosure is not limited thereto, and the present disclosure is only defined by the scope of the appended claims.

Unless otherwise stated herein, when a part such as a layer, a membrane, an area, a plate, and the like, is described as being disposed “on” another part, it includes not only a case where the part is “directly on” another part, but also a case where there are other parts therebetween.

Unless otherwise stated herein, the singular may also include the plural. In addition, unless otherwise stated, the term “A or B” may mean “including A, including B, or including A and B.”

In the present specification, “a combination thereof” may mean a mixture, stack, composite, copolymer, alloy, blend, or reaction product of constituents.

Unless otherwise defined herein, ‘a particle size D50’ may refer to a size of a particle with a cumulative volume of 50% by volume in a particle size distribution. The particle size distribution may be measured by methods known to those skilled in the art. For example, the particle size distribution may be measured using a particle size analyzer, a transmission electron microscope photograph, or a scanning electron microscope photograph. As another method, the particle size distribution may be obtained by measuring the particle size using a measuring device using dynamic light scattering, performing data analysis to count the number of particles for each particle size range, and then calculating the particle size D50 therefrom. Alternatively, the particle size distribution may be measured using a laser diffraction method. When measuring the particle size distribution by the laser diffraction method, for example, the particle size D50 based on 50% of a particle size distribution in the measuring device may be calculated by dispersing particles to be measured in a dispersion medium, then introducing the dispersion medium into a commercially available laser diffraction particle size measuring device (e.g., Microtrac's MT 3000), and radiating ultrasonic waves of about 28 kHz with an output of 60 W.

If (when) the particle is spherical, size can mean diameter.

In the present specification, “(meth)acryl” refers to acryl and/or methacryl.

Hereinafter, unless otherwise defined, “substitution” means that hydrogen in a compound is substituted with a substituent such as or including at least one of a C1 to C30 alkyl group, a C2 to C30 alkenyl group, a C2 to C30 alkynyl group, a C6 to C30 aryl group, a C7 to C30 alkylaryl group, a C1 to C30 alkoxy group, a C1 to C30 heteroalkyl group, a C3 to C30 heteroalkylaryl group, a C3 to C30 cycloalkyl group, a C3 to C15 cycloalkenyl group, a C6 to C30 cycloalkynyl group, a C2 to C30 heterocycloalkyl group, a halogen (F, Cl, Br, or I), a hydroxy group (—OH), a nitro group (—NO₂), a cyano group (—CN), an amino group (—NRR′) (here, R and R′ are each independently hydrogen or a C1 to C6 alkyl group), a sulfobetaine group (—RR′N⁺(CH₂)˜SO₃—, n is a natural number from 1 to 10), a carboxybetaine group (—RR′N⁺(CH₂)˜COO⁻, n is a natural number from 1 to 10) (here, R and R′ are each independently a C1 to C20 alkyl group), an azido group (—N₃), an amidino group (—C(═NH)NH₂), a hydrazino group (—NHNH₂), a hydrazono group (═N(NH₂)), a carbamoyl group (—C(O)NH₂), a thiol group (—SH), an acyl group (—C(═O)R, here, R denotes hydrogen, a C1 to C6 alkyl group, a C1 to C6 alkoxy group, or a C6 to C12 aryl group), a carboxyl group (—COOH) or a salt thereof (—C(═O)OM, here, M denotes an organic or inorganic cation), a sulfonic acid group (—SO₃H) or a salt thereof (—SO₃M, here, M denotes an organic or inorganic cation), a phosphate group (—PO₃H₂) or a salt thereof (˜PO₃MH or —PO₃M₂, here, M denotes an organic or inorganic cation), and a combination thereof.

Hereinafter, the C1 to C3 alkyl group may be or include at least one of a methyl group, an ethyl group, or a propyl group. The C1 to C10 alkylene group may be or include, for example, a C1 to C6 alkylene group, a C1 to C5 alkylene group, or a C1 to C3 alkylene group and may be or include, for example, a methylene group, an ethylene group, or a propylene group. The C3 to C20 cycloalkylene group may be or include, for example, a C3 to C10 cycloalkylene group, or a C5 to C10 cycloalkylene group, for example, a cyclohexylene group. The C6 to C20 arylene group may be or include, for example, a C6 to C10 arylene group, for example, a phenylene group. The C3 to C20 heterocyclic group may be or include, for example, a C3 to C10 heterocyclic group, for example, a pyridine group.

Hereinafter, “hetero” means including one or more heteroatoms such as or including at least one of N, O, S, Si, and P.

In addition, in the chemical formulas, the symbol * refers to a part that is connected to the same or different atom, group, or structural unit. Unless specifically stated otherwise in a chemical formula shown herein, it may be assumed that hydrogen is bonded in the structure of the chemical formula.

Hereinafter, “alkali metal” refers to an element belonging to Group 1 of the periodic table, such as, e.g., lithium, sodium, potassium, rubidium, cesium, or francium, and may be present in a cationic or neutral state.

In the present specification, when describing a numerical range, “X to Y” means “X or more and Y or less (X≤ and ≤Y).”

When the terms “about” or “substantially” are used in this specification in connection with a numerical value, it is intended that the associated numerical value include a tolerance of +10% around the stated numerical value. When ranges are specified, the range includes all values therebetween such as increments of 0.1%.

Hereinafter, a separator for a rechargeable battery of the present disclosure and a rechargeable battery including the same are described in detail.

Hereinafter, only rechargeable lithium batteries are described. However, the present disclosure may also be applied to rechargeable batteries of different metal ions in addition to rechargeable lithium batteries.

According to one example embodiment, the separator for a rechargeable battery includes a porous substrate, a first coating layer and a first adhesive layer located, e.g., sequentially located, on a first surface of the porous substrate, and a second coating layer and a second adhesive layer located, e.g., sequentially located, on a second surface of the porous substrate. Each of the first coating layer and the second coating layer includes a crosslinked product of a binder and a crosslinking agent, and a filler, the binder includes a (meth)acrylic binder including a first structural unit derived from (meth)acrylic acid, (meth)acrylate, or a salt thereof, a second structural unit derived from hydroxyalkyl (meth)acrylate, and a third structural unit derived from (meth)acrylamido sulfonic acid or a salt thereof. The crosslinking agent includes an aziridine-based crosslinking agent, the filler includes a mixture of a first filler and a second filler, wherein the first filler is an inorganic filler and the second filler is a metal-organic framework structure (MOF). The first adhesive layer includes a (meth)acrylic based adhesive binder, and the second adhesive layer includes a fluorine-based adhesive binder having a carbonyl group (C═O).

According to one example embodiment, the first adhesive layer may be laminated to a negative electrode of a battery, and the second adhesive layer may be laminated to a positive electrode of the battery.

In one example embodiment, the crosslinked product may be or include a thermally crosslinked product.

According to one example embodiment, each of the first coating layer and the second coating layer may be formed of or include a composition for a coating layer including the (meth)acrylic binder, the aziridine-based crosslinking agent, and the filler.

The separator can provide a low thermal shrinkage rate, and high rate characteristics during charging and discharging, low membrane resistance, and high adhesion to an electrode plate.

In one example embodiment, the separator may have a dry thermal shrinkage rate of about 5% or less in the machine direction (MD) and the transverse direction (TD), a wet thermal shrinkage rate of about 10% or less, and a membrane resistance of about 0.65Ω or less. Here, the MD and TD are substantially the same direction as the MD and TD of the porous substrate, respectively.

In one example embodiment, the separator may have a rate characteristic of about 99% or more or 100% or more during charging and discharging.

In one example embodiment, the separator may have an adhesion to the positive electrode of about 1.0 gf/mm or more, and an adhesion to a negative electrode of about 0.6 gf/mm or more.

The first coating layer and the second coating layer including only the filler, e.g., a mixture of the first filler and the second filler, cannot provide a separator having the above-described dry thermal shrinkage rate range and wet thermal shrinkage rate range. A separator having the first coating layer and the second coating layer including the filler and a crosslinked product of the (meth)acrylic binder and the aziridine-based crosslinking agent can have the above-described dry thermal shrinkage rate range and wet thermal shrinkage rate range, and the above-described membrane resistance range.

A separator having a coating layer formed of or including a composition for a coating layer, which includes the (meth)acrylic binder but does not include an aziridine-based crosslinking agent as a crosslinking agent or contains a crosslinking agent other than an aziridine-based crosslinking agent, may decrease battery reliability due to an increase in one or more of the above-described dry thermal shrinkage rate and/or wet thermal shrinkage rate. According to one example embodiment, the aziridine-based crosslinking agent may be included in an amount of about 95 wt % or more, for example, in a range of about 98 wt % to about 100 wt %, or 100 wt %, of the total crosslinking agent in the composition for a coating layer.

A separator having a coating layer formed of or including a composition for a coating layer, which includes the aziridine-based crosslinking agent but does not include the (meth)acrylic binder or contains a binder other than the (meth)acrylic binder, has a high thermal shrinkage rate, high membrane resistance, and high air permeability, which may present a challenge with the capacity, lifespan, and safety of a battery. According to one example embodiment, the (meth)acrylic binder may be included in an amount of about 95 wt % or more, for example, in a range of about 98 wt % to about 100 wt %, or 100 wt %, of the total binder in the composition.

The filler includes a mixture of the first filler and the second filler. A separator formed of or including a composition for a coating layer including only the first filler may have poor rate characteristics during charging and discharging of a battery. A separator formed of or including a composition for a coating layer including only the second filler may have poor battery reliability due to an increased dry thermal shrinkage rate and/or wet thermal shrinkage rate. According to one example embodiment, the mixture of the first filler and the second filler may be included in an amount of about 95 wt % or more, for example, a range of about 98 wt % to about 100 wt %, or 100 wt %, of the total filler in the composition.

The first adhesive layer includes a (meth)acrylic based adhesive binder, and the second adhesive layer includes a fluorine-based adhesive binder having a carbonyl group. A separator having the first adhesive layer and the second adhesive layer can provide high adhesion to the positive electrode and the negative electrode, and can be advantageous in providing remarkably a low dry shrinkage rate and a remarkably low wet shrinkage rate.

### First Coating Layer

The first coating layer may be or include a heat-resistant layer.

The binder includes a (meth)acrylic binder including a first structural unit derived from (meth)acrylic acid, (meth)acrylate, or a salt thereof, a second structural unit derived from hydroxyalkyl (meth)acrylate, and a third structural unit derived from (meth)acrylamido sulfonic acid or a salt thereof.

In one example embodiment, the (meth)acrylic binder may be or include a non-adhesive binder.

According to one example embodiment, the (meth)acrylic binder may be or include a salt-based binder, for example, an alkali metal salt-based binder. Here, the alkali metal may be or include at least one of lithium, sodium, potassium, rubidium, or cesium. In this case, it may be possible to lower the membrane resistance of the separator.

The (meth)acrylic binder may fix the filler onto the porous substrate, enable the first coating layer to adhere to the porous substrate and the electrode, and contribute to improving the heat resistance, air permeability, and oxidation resistance of the separator. In addition, the (meth)acrylic binder can facilitate the movement of lithium ions, thereby lowering membrane resistance, improving ion conductivity, increasing the adhesion of the first coating layer to the porous substrate and the electrode, and increasing the dispersibility of the filler within the first coating layer. In addition, the (meth)acrylic binder can provide a separator having low membrane resistance, a low dry thermal shrinkage rate, and a low wet thermal shrinkage rate in the first coating layer including the filler described below.

The sum of the content of the first structural unit, the second structural unit, and the third structural unit may be about 95 mol % or more, for example, a range of about 95 mol % to about 100 mol %, for example, 100 mol %, based on 100 mol % of the (meth)acrylic binder. In the above range, the above-described separator effect may be readily implemented.

The first structural unit is derived from (meth)acrylic acid, (meth)acrylate, or a salt thereof, and may fix the filler onto the porous substrate while providing adhesiveness so that the first coating layer may be attached to the porous substrate and the electrode, and may contribute to improving the heat resistance and air permeability of the separator. In addition, the first structural unit can improve the dispersibility of the composition for a coating layer by having a carboxyl functional group (—C(═O)O—) within the structural unit.

The first structural unit may be represented by any one of the following Chemical Formulas 1 to 3:

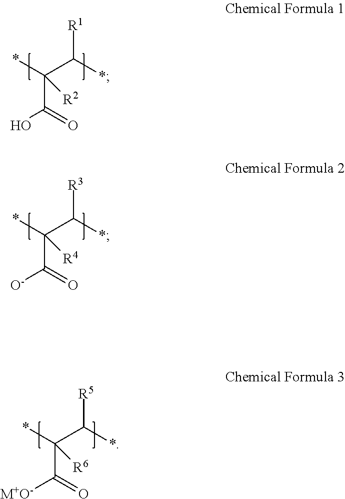

The first structural unit may be included in an amount in a range of about 20 mol % to about 75 mol %, for example, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74.75 mol %, 25 mol % to 70 mol %, 30 mol % to 65 mol %, 30 mol % to 60 mol %, or 40 mol % to 65 mol %, based on 100 mol % of the binder for the rechargeable lithium battery. When the first structural unit is included in the above range, the separator may exhibit low membrane resistance, desired or improved adhesion to the porous substrate and the electrode, heat resistance, air permeability, and oxidation resistance.

According to one example embodiment, the first structural unit may include the structural unit represented by Chemical Formula 2 and the structural unit represented by Chemical Formula 3, in which case the structural unit represented by Chemical Formula 2 and the structural unit represented by Chemical Formula 3 may be included in a molar ratio in a range of about 10:1 to 1:2, 10:1 to 1:1, or 5:1 to 1:1.

According to another example embodiment, the first structural unit may include only the structural unit represented by Chemical Formula 2 or Chemical Formula 3.

The second structural unit is derived from hydroxyalkyl (meth)acrylate and may fix the filler onto the porous substrate while providing adhesiveness so that the first coating layer may be attached to the porous substrate and the electrode. In addition, the second structural unit can improve the dispersibility of the composition for a first coating layer by having a carboxyl functional group (—C(═O)O—) within the structural unit.

The second structural unit may be represented by the following Chemical Formula 4:

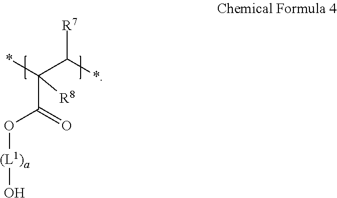

The second structural unit may be included in an amount in a range of about 1 mol % to about 20 mol %, for example, 1, 2, 3, 4, 5, 6, 7, 8, 9, 10, 11, 12, 13, 14, 15, 16, 17, 18, 19, 20 mol %, 2 mol % to 15 mol %, 5 mol % to 15 mol %, or 5 mol % to 10 mol %, based on 100 mol % of the binder for the rechargeable lithium battery. In the above range, it may be possible to increase the adhesion of the coating layer to the porous substrate and the electrode.

The second structural unit may be or include, for example, a structural unit derived from hydroxyalkyl (meth)acrylate. Here, the alkyl may be or include a C1 to C20 alkyl, a C1 to C10 alkyl, or a C1 to C6 alkyl.

The hydroxyalkyl (meth)acrylate may include, for example, at least one or more of hydroxymethyl (meth)acrylate, 2-hydroxyethyl (meth)acrylate, 2-hydroxypropyl (meth)acrylate, 2-hydroxybutyl (meth)acrylate, 4-hydroxybutyl (meth)acrylate, and 6-hydroxyhexyl (meth)acrylate.

The third structural unit derived from the (meth)acrylamido sulfonic acid or a salt thereof may lower the membrane resistance of the separator by increasing the movement of lithium ions in the presence of the first structural unit and the second structural unit.

The third structural unit may enhance the heat resistance of the separator due to an increase in glass transition temperature by including a bulky functional group derived from (meth)acrylamido sulfonic acid or a salt thereof. When the third structural unit includes a functional group derived from a salt of (meth)acrylamido sulfonic acid, the metal (M) can move through the third structural unit by a sulfonic acid functional group substituted with the metal (M), thereby exhibiting an effect of lowering membrane resistance.

The third structural unit may be represented by at least one of the following Chemical Formula 5, Chemical Formula 6, Chemical Formula 7, or a combination thereof:

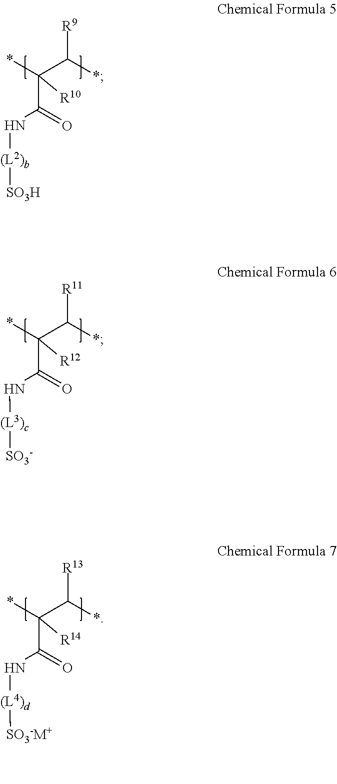

The third structural unit may include only one, or two or more, of the structural unit represented by Chemical Formula 5, the structural unit represented by Chemical Formula 6, and the structural unit represented by Chemical Formula 7. As an example, the third structural unit may include the structural unit represented by Chemical Formula 6, and as another example, the third structural unit may include the structural unit represented by Chemical Formula 6 and the structural unit represented by Chemical Formula 7.

The third structural unit may be or include, for example, a structural unit derived from (meth)acrylamidoalkane sulfonic acid or a salt thereof. Here, the alkane may be or include a C1 to C20 alkane, a C1 to C10 alkane, or a C1 to C6 alkane, and the alkyl may be or include a C1 to C20 alkyl, a C1 to C10 alkyl, or a C1 to C6 alkyl. The salt is composed of or include the above-described sulfonic acid and a desired ion. The ion may be or include, for example, an alkali metal ion, in which case the salt may be or include a sulfonic acid alkali metal salt.

For example, the (meth)acrylamidoalkane sulfonic acid may be 2-(meth)acrylamido-2-methylpropane sulfonic acid.

The third structural unit may be included in an amount in a range of about 20 mol % to about 75 mol %, for example, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75 mol %, 25 mol % to 70 mol %, 20 mol % to 65 mol %, 30 mol % to 65 mol %, or 30 mol % to 60 mol % in the (meth)acrylic binder. When the third structural unit is included in the above range, the (meth)acrylic binder and a separator including the same may exhibit significantly low membrane resistance.

The description of the above Chemical Formulas 1 to 7 is as follows.

R¹ to R¹⁴ may each independently be or include hydrogen or a C1 to C10 alkyl group.

For example, R¹ to R⁷ and R⁹ to R¹⁴ may each be or include hydrogen or a methyl group; and R⁸ may be or include a methyl group.

L¹ to L⁴ may each independently be or include a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group. For example, L¹ may be or include a methylene group or an ethylene group; and L² to L⁴ may each independently be *—C(CH₃)₂—CH₂—*.

a, b, c, and d may each independently be an integer in a range from 0 to 2. For example, a, b, c, and d may all be equal to 1.

M may be or include an alkali metal, and the alkali metal may be or include at least one of lithium, sodium, potassium, rubidium, or cesium. For example, M may be lithium or sodium.

A representative example of the (meth)acrylic binder according to one example embodiment is as shown in the following Chemical Formula 8:

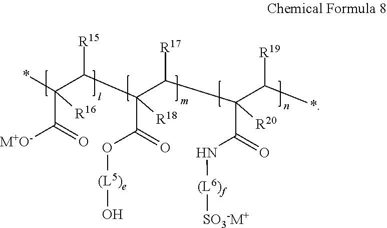

The description of the above Chemical Formula 8 is as follows.

R¹⁵ to R²⁰ may each independently be or include hydrogen or a C1 to C10 alkyl group. For example, R¹⁵ to R¹⁷ and R¹⁹ and R²⁰ may each be or include hydrogen or a methyl group; and R¹⁸ may be or include a methyl group.

L⁵ and L⁶ may each independently be or include a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group. For example, L⁵ may be or include a methylene group or an ethylene group, and L⁶ may be or include *—C(CH₃)₂—CH₂—*.

M may be or include an alkali metal, and the alkali metal may be or include at least one of lithium, sodium, potassium, rubidium, or cesium. For example, M may be or include lithium or sodium.

e and f may each independently be an integer in a range from 0 to 2. For example, e and f may all be equal to 1.

l, m, and n may be molar ratios of each unit, and 1+m+n=1. For example, 0.20≤l≤0.75, 0.01≤m≤0.2, and 0.2≤n≤0.75, for example, 0.25≤l≤0.70, 0.01≤m≤0.15, and 0.25≤n≤0.75, or 0.3≤l≤0.65, 0.05≤m≤0.15, and 0.3≤n≤0.65.

The (meth)acrylic binder may include an alkali metal. The alkali metal may be present in the form of a cation and may be or include, for example, at least one of lithium, sodium, potassium, rubidium, or cesium. For example, the alkali metal may be present in the form of a salt combined with the (meth)acrylic binder. The alkali metal may assist the synthesis of the (meth)acrylic binder in an aqueous solvent, improve the adhesiveness of the coating layer, and improve the heat resistance, air permeability, and oxidation resistance of the separator.

The alkali metal may be included in an amount in a range of about 1 wt % to about 40 wt %, for example, 1 wt % to 30 wt %, 1 wt % to 20 wt %, or 10 wt % to 20 wt % of the alkali metal and the (meth)acrylic binder. For example, the (meth)acrylic binder and the alkali metal may be included in a weight ratio in a range of about 99:1 to about 60:40, a weight ratio of 99:1 to 70:30, for example, a weight ratio of 99:1 to 80:20, for example, a weight ratio of 90:10 to 80:20.

The alkali metal may be included in an amount in a range of about 0.1 mol % to about 1.0 mol % based on the total content of the alkali metal and the (meth)acrylic binder. When the alkali metal is included within the above range, the coating layer may have desired or improved adhesiveness, and a separator including the coating layer may exhibit desired or improved heat resistance, air permeability, and oxidation resistance.

The (meth)acrylic heat-resistant binder may have various forms, such as an alternating polymer in which the structural units are alternately distributed, a random polymer in which the structural units are randomly distributed, or a graft polymer in which some of the structural units are grafted.

A weight average molecular weight of the (meth)acrylic binder may be in a range of about 100,000 g/mol to about 1,000,000 g/mol, 100,000 g/mol to 500,000 g/mol, 100,000 g/mol to 150,000 g/mol, 130,000 g/mol to 200,000 g/mol, or 300.00 g/mol to 900,000 g/mol. When the weight average molecular weight of the (meth)acrylic binder satisfies the above range, it may exhibit desired or improved adhesiveness and low resistance. The weight average molecular weight may be or include a polystyrene-converted average molecular weight measured using gel permeation chromatography.

The (meth)acrylic binder may be prepared by a solution polymerization method.

According to one example embodiment, the (meth)acrylic binder may be included in a film form in the coating layer of the separator.

The crosslinking agent includes an aziridine-based crosslinking agent.

The aziridine-based crosslinking agent may crosslink the (meth)acrylic binder to facilitate the separator reaching the above-described thermal shrinkage range in the electrolyte. In addition, the aziridine-based crosslinking agent may crosslink the (meth)acrylic binder to significantly lower the membrane resistance of the separator. In addition, the aziridine-based crosslinking agent may crosslink the (meth)acrylic binder to increase the adhesion to the electrode.

The aziridine-based crosslinking agent may be or include a bifunctional or higher aziridine-based crosslinking agent. Here, “bifunctional or higher” means that there are two or more aziridine groups in the molecule. According to one example embodiment, the aziridine-based crosslinking agent may be or include a bifunctional or trifunctional aziridine-based crosslinking agent.

For example, the aziridine-based crosslinking agent may include at least one or more of N,N′-toluene-2,4-bis(1-aziridine carboxamide), N,N′-(methylenedi-p-phenylene)bis(aziridine-1-carboxamide), triethylenemelamine, 1,1-isophthaloyl bis(2-methylaziridine), tris(1-aziridinyl)phosphine oxide, N,N-hexamethylene-bis(aziridine carboxamide), trimethylolpropane tris(2-methyl-1-aziridine propionate), trimethylolpropane tris(beta-N-aziridinyl)propionate, and pentaerythritol tris(3-(1-aziridinyl)propionate).

The crosslinking agent, for example, the aziridine-based crosslinking agent, may be included in a desired amount with respect to the binder, for example, the (meth)acrylic binder. According to one example embodiment, the crosslinking agent may be included in an amount in a range of about 5 parts by weight to about 50 parts by weight, for example, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50 parts by weight, 5 parts by weight to 30 parts by weight, 5 parts by weight to 25 parts by weight, or 5 parts by weight to 20 parts by weight, based on 100 parts by weight of the (meth)acrylic binder. In the above range, the thermal shrinkage rate and membrane resistance of the separator in the electrolyte may be significantly lowered.

The filler includes a mixture of a first filler and a second filler, wherein the first filler is an inorganic filler and the second filler is a metal organic framework (MOF) structure.

The first filler may have an average particle size D50 in a range of about 100 nm to about 200 nm, for example, 100, 105, 110, 115, 120, 125, 130, 135, 140, 145, 150, 155, 160, 165, 170, 175, 180, 185, 190, 195, 200 nm, 120 nm to 180 nm or 150 nm. In the above range, it may be possible to reach the above-described dry thermal shrinkage rate and wet thermal shrinkage rate when the first filler is combined with the MOF described below.

The first filler may be or include a ceramic material as an inorganic filler. The inorganic filler may include at least one of a metal oxide, a metalloid oxide, a metal fluoride, a metal hydroxide, or a combination thereof. The inorganic filler may include, for example, at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof, but is not limited thereto. For example, the filler may be boehmite.

The first filler may be spherical, plate-shaped, cubic, or amorphous. For example, the first filler may be cubic, and the cubic type may have a significantly lower thermal shrinkage rate as described above.

The second filler may include a compound in which a metal cation and a linker are coordinately bonded. For example, the second filler may be or include a microporous crystal composed of or including a metal or a metal cluster and a linker connecting them through a coordinate bond.

In one example embodiment, the second filler may include a zinc or cobalt ion as a metal ion, and an imidazole-based compound (or a derivative of an imidazole-based compound) as a linker, which are linked by a coordinate bond. The imidazole-based compound may be or include one or more of imidazole, methyl imidazole including 2-methylimidazole, and benzimidazole. A nitrogen atom of the imidazole-based compound can form a coordinate bond with at least one of the metal ions.

The second filler may include a zeolitic imidazolate framework (ZIF)-based compound including ZIF-8 and the like.

The second filler may have an average particle size D50 in a range of about 100 nm to about 200 nm, for example, 100, 105, 110, 115, 120, 125, 130, 135, 140, 145, 150, 155, 160, 165, 170, 175, 180, 185, 190, 195, 200 nm, 120 nm to 180 nm, or 150 nm. In the above range, when the second filler is combined with the first filler, it may be possible to reach the above-described dry heat shrinkage rate and wet heat shrinkage rate.

The first filler and the second filler may be included in a weight ratio in a range of about 50:50 to about 95:5 based on 100 parts by weight of the mixture. In the above range, it may be advantageous for lowering the dry thermal shrinkage rate and the wet thermal shrinkage rate. For example, the weight ratio may be in a range of 50:50, 55:45, 60:40, 65:35, 70:30, 75:25, 80:20, 85:15, 90:10, 95:5, 55:45 to 95:5, or a range of 60:40 to 90:10, and in the above range, rate characteristics may be further improved.

The filler, that is, the mixture, and the (meth)acrylic binder, may be included in a (meth)acrylic binder:mixture mass ratio a range of about 1:10 to about 1:50, for example, 1:10, 1:15, 1:20, 1:25, 1:30, 1:35, 1:40, 1:45, 1:50, a range of 1:10 to 1:40, or a range of 1:20 to 1:30. In the above range, there may be an effect of improving heat resistance within the electrolyte.

The filler, e.g., the mixture, may be included in an amount in a range of about 50 wt % to about 99 wt %, for example, 70 wt % to 99 wt %, for example, 75 wt % to 99 wt %, for example, 80 wt % to 99 wt %, for example, 85 wt % to 99 wt %, for example, 90 wt % to 99 wt %, for example, 95 wt % to 99 wt % of the total amount of the coating layer. When the filler is included within the above range, desired or improved heat resistance, durability, oxidation resistance and stability may be exhibited.

The coating layer may have a thickness in a range of about 0.01 μm to about 20 μm, and within the above range, the thickness may be in a range of 0.01 μm to 7 μm, 0.1 μm to 5 μm, or 0.1 μm to 3 μm. For example, the first coating layer may have a thickness in a range of about 0.1 μm to about 2 μm.

The ratio of the thickness of the first coating layer to the thickness of the porous substrate may range from about 0.01 to about 0.7, for example, from 0.01 to 0.5, from 0.01 to 0.4, or from 0.01 to 0.3. In the above range, the separator can exhibit desired or improved air permeability, heat resistance, and adhesiveness.

### First Adhesive Layer

The first adhesive layer includes a (meth)acrylic based adhesive binder. The (meth)acrylic based adhesive binder may increase the adhesion to a negative electrode. The adhesive binder may be in a particle shape and a crosslinked shape.

The (meth)acrylic based adhesive binder may include a (meth)acrylate polymer or copolymer. According to one example embodiment, the adhesive binder may be or include a crosslinked (meth)acrylate polymer or copolymer. For example, the adhesive binder may include a crosslinked polymethyl methacrylate (PMMA)-based polymer.

In order to prepare the crosslinked (meth)acrylic polymer, a crosslinking agent may be further added during a polymerization step. The (meth)acrylic adhesive binder may have a glass transition temperature in a range of about 50° C. to about 110° C., for example, a range of 50° C. to 70° C. In the above range, not only is the electrode adhesion desired or improved, but also the ionic conductivity is desired. The glass transition temperature may be measured using differential scanning calorimetry (DSC). For example, 2 mg of a polymer is input into a high pressure pan for DSC measurement, a temperature range is set to a range of about 25° C. to about 200° C., a temperature increase rate is set to about 10° C./min, and the glass transition temperature is obtained in a controlled atmosphere.

The (meth)acrylic based adhesive binder may be included in an amount of about 95 wt % or more, for example, in a range of about 95 wt % to about 100 wt %, or 100 wt % in the first adhesive layer.

The first adhesive layer may have a thickness in a range of about 0.01 μm to about 20 m, and within the above range, the thickness may be in a range of 0.01 μm to 7 μm, 0.1 μm to 5 μm, or 0.1 μm to 3 μm. For example, the first adhesive layer may have a thickness in a range of about 0.1 μm to 2 μm.

### Second Coating Layer

The second coating layer may be or include a heat-resistant layer.

The binder includes a (meth)acrylic binder including a first structural unit derived from (meth)acrylic acid, (meth)acrylate, or a salt thereof, a second structural unit derived from hydroxyalkyl (meth)acrylate, and a third structural unit derived from (meth)acrylamide sulfonic acid or a salt thereof.

Details regarding the (meth)acrylic binder are omitted because the (meth)acrylic binder is substantially the same as the (meth)acrylic binder in the first coating layer. The detailed composition of the (meth)acrylic binder in the first coating layer may be substantially the same as the (meth)acrylic binder in the second coating layer.

The crosslinking agent includes an aziridine-based crosslinking agent, and the filler includes a mixture of a first filler and a second filler. The detailed composition of each of the aziridine-based crosslinking agent, the first filler, and the second filler may be substantially the same as the composition described above with respect to the first coating layer.

### Second Adhesive Layer

The second adhesive layer includes a fluorine-based adhesive binder having a carbonyl group (C═O). The fluorine-based adhesive binder may be advantageous in providing high adhesion to a positive electrode.

The adhesive binder includes a mixture of a fluorine-based homopolymer or copolymer, and an interpenetrating polymer network (IPN) binder (hereinafter also referred to as an IPN binder) of a fluorine-based crosslinked polymer and an acrylate-based crosslinked polymer. The mixture may be included in the adhesive layer to advantageously increase the adhesion to the positive electrode.

In one example embodiment, the adhesive binder may be or include an aqueous binder.

According to one example embodiment, the mixture may be included in an amount of about 95 wt % or more, for example, in a range of about 95 wt % to about 100 wt %, or 100 wt % of the adhesive binder.

The fluorine-based homopolymer may include a polyvinylidene fluoride-based homopolymer.

The fluorine-based copolymer may include a polyvinylidene fluoride-based copolymer.

The fluorine-based homopolymer or copolymer is a material having a high melting point (Tm) in a range of about 100° C. to about 200° C., and the particle shape thereof is maintained even after a thermal compression process, thereby contributing to securing air permeability of the separator after thermal compression. The fluorine-based homopolymer or copolymer may have a melting point of about 100° C. or higher, about 120° C. or higher, or about 130° C. or higher and about 200° C. or lower, about 180° C. or lower, or about 170° C. or lower.

The fluorine-based homopolymer or copolymer may be located within the network structure of the IPN binder to enhance air permeability. In addition, the fluorine-based homopolymer or copolymer can provide desired or improved adhesiveness.

The fluorine-based homopolymer or copolymer may have a particle size D50 in a range of about 50 nm to about 1000 nm. In the above range, desired or improved air permeability may be provided to the separator for a rechargeable lithium battery. For example, the particle size D50 may be about 50 nm or more, about 100 nm or more, about 150 nm or more, about 200 nm or more, about 1000 nm or less, about 800 nm or less, about 600 nm or less, about 400 nm or less, or about 300 nm or less.

The fluorine-based homopolymer or copolymer may have a weight average molecular weight of about 100,000 g/mol or more, about 200,000 g/mol or more, about 300,000 g/mol or more, and/or about 1,500,000 g/mol or less.

According to one example embodiment, the fluorine-based homopolymer or copolymer may have a carbonyl (C═O) functional group. The carbonyl (C═O) functional group may add an adhesion function when the homopolymer is applied to an adhesive layer. A method for introducing a carbonyl functional group into the homopolymer or copolymer may be or include a conventional method known to those skilled in the art.

The IPN binder may be or include a particle-type binder in which the fluorine-based crosslinked polymer and the acrylate-based crosslinked polymer form a interpenetrating polymer network. The two crosslinked polymers forming the interpenetrating polymer network can impart desired or improved adhesiveness to the separator for a rechargeable lithium battery of one example embodiment.

For example, the acrylate-based crosslinked polymer and the fluorine-based crosslinked polymer each have a network structure, and may be entangled in a network form.

The acrylate-based crosslinked polymer may be or include a crosslinked polymer such as or including at least one of polymethyl methacrylate, polymethacrylate, polyethyl acrylate, polyacrylate, polybutylacrylate, and the like.

The fluorine-based crosslinked polymer may be or include a crosslinked polymer such as or including at least one of a homopolymer including only a vinylidene fluoride monomer-derived structural unit, a copolymer including a vinylidene fluoride-derived structural unit and a structural unit derived from another monomer, and the like.

The copolymer may include, but is not limited to, a vinylidene fluoride-derived structural unit and one or more structural units derived from chlorotrifluoroethylene, trifluoroethylene, hexafluoropropylene, ethylene tetrafluoride and ethylene monomers. For example, the copolymer may be or include a polyvinylidene fluoride-hexafluoropropylene (PVdF-HFP) copolymer including a vinylidene fluoride monomer-derived structural unit and a hexafluoropropylene monomer-derived structural unit.

According to one example embodiment, the fluorine-based adhesive binder may be or include an aqueous particle-type adhesive binder.

In one example embodiment, the copolymer adhesive binder includes about 75 mol % to about 90 mol % of repeating units derived from vinylidene fluoride and about 10 mol % to about 25 mol % of repeating units derived from hexafluoropropylene, based on a total of 100 mol % vinylidene fluoride and hexafluoropropylene, and may further include repeating units derived from a monomer having a carbonyl group.

A weight ratio of the acrylate-based crosslinked polymer and the fluorine-based crosslinked polymer may be in a range of about 8:2 to about 1:9. Within the above range, desired or improved adhesion may be maintained even after thermal compression of the separator for a rechargeable lithium battery of the example embodiment. For example, the weight ratio may range from about 8:2 to about 1:9, from 7:3 to 2:8, from 6:4 to 2:8, or from 5:5 to 3:7.

A weight average molecular weight of the IPN binder may be about 100,000 g/mol or more. In the above range, desired or improved adhesion may be maintained even after thermal compression of the separator for a rechargeable lithium battery. For example, the weight average molecular weight of the IPN binder may be about 200,000 g/mol or more or about 300,000 g/mol or more, and about 1,500,000 g/mol or less.

The fluorine-based homopolymer in the adhesive layer: the interpenetrating polymer network (IPN) binder of the fluorine-based cross-linked polymer and the acrylate-based cross-linked polymer may be included in a weight ratio in a range of about 95:5 to about 15:85 based on a total of 100 wt %. In the above range, there may be a synergistic effect in achieving desired or improved adhesion and enhancing air permeability. For example, the weight ratio may be in a range of 95:5 to 15:85, in a range of 95:5, 90:10, 85:15, 80:20, 75:25, 70:30, 65:35, 60:40, 55:45, 50:40, 45:55, 40:60, 35:65, 30:70, 25:75, 20:80, 15:85, 85:15 to 15:85, or in a range of 80:20 to 20:80.

A loading amount of the mixture may be in a range of about 0.1 g/m² to about 1.0 g/m² per one side of the substrate. In the above range, desired or improved adhesion, thermal stability, and structural stability may be enhanced.

The adhesive binder, for example, the mixture, may be included in an amount in a range of about 1 wt % to about 20 wt %, for example 5 wt % to 20 wt %, for example, 5 wt % to 15 wt %, based on the total amount of the coating layer. Within the above range, adhesion to the electrode is expressed and battery resistance does not increase, so there may be no limitation in capacity implementation.

The second adhesive layer may have a thickness in a range of about 0.01 μm to about 20 μm, and within the above range, the thickness may be in a range of 0.01 μm to 7 μm, in a range of 0.1 μm to 5 μm, or in a range of 0.1 μm to 3 μm. For example, the second adhesive layer may have a thickness in a range of 0.1 μm to 2 μm.

### Porous Substrate

The porous substrate may be or include a base having multiple pores and commonly used in electrochemical devices. The porous substrate may be or include a polymer membrane formed of or including any one polymer such as or including at least one of a polyolefin such as polyethylene or polypropylene, polyester such as polyethylene terephthalate or polybutylene terephthalate, polyacetal, polyamide, polyimide, polycarbonate, polyether ether ketone, polyaryl ether ketone, polyetherimide, polyamideimide, polybenzimidazole, polyethersulfone, polyphenylene oxide, cyclic olefin copolymer, polyphenylene sulfide, polyethylene naphthalate, glass fiber, Teflon, and polytetrafluoroethylene, or a copolymer or mixture of two or more types thereof.

The porous substrate may be or include, for example, a polyolefin-based base containing a polyolefin, and the polyolefin-based base may have a desired or improved shutdown function, thereby contributing to increasing the safety of the battery. The polyolefin-based base may be or include, for example, at least one of a polyethylene single film, a polypropylene single film, a polyethylene/polypropylene double film, a polypropylene/polyethylene/polypropylene triple film, and a polyethylene/polypropylene/polyethylene triple film. In addition, the polyolefin-based resin may include a non-olefin resin in addition to an olefin resin or include a copolymer of olefin and non-olefin monomers.

The porous substrate may have a thickness ranging from about 1 μm to about 40 μm, for example, from 1 μm to 30 μm, from 1 μm to 20 μm, or from 5 μm to 15 μm.

The porous substrate may exhibit desired or improved air permeability and have an air permeability value of, for example, less than about 200 sec/100 cc, for example, about 190 sec/100 cc or less, or about 180 sec/100 cc or less. Within the above range, the porous substrate may be used in a separation membrane.

A separator for a rechargeable lithium battery according to one example embodiment may be formed by applying a composition for forming a coating layer on one side, or on both sides, of a porous substrate, and then drying the porous substrate. The drying may be performed using conventional methods known to those skilled in the art.

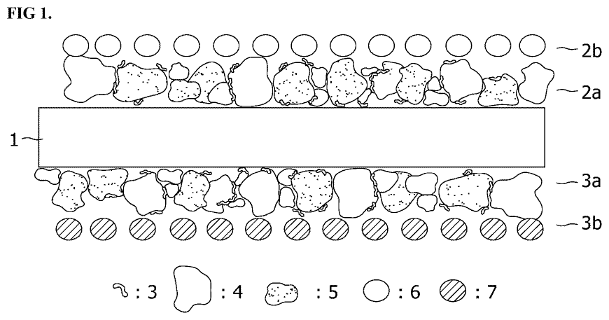

FIG. 1 is a cross-sectional view showing a separator for a rechargeable lithium battery according to one example embodiment.

Referring to FIG. 1, the separator for a rechargeable lithium battery may include a porous substrate 1, a first coating layer 2a and a first adhesive layer 2b located, e.g., sequentially located, on a first surface of the porous substrate 1, and a second coating layer 3a and a second adhesive layer 3b located, e.g., sequentially located, on a second surface of the porous substrate 1. The first coating layer 2a may include a crosslinked product 3 of a (meth)acrylic binder and an aziridine-based crosslinking agent, a first filler 4, and a second filler 5. The first adhesive layer 2b may include a (meth)acrylic-based adhesive binder 6. The second coating layer 3a may include a crosslinked product 3 of a (meth)acrylic binder and an aziridine-based crosslinking agent, a first filler 4, and a second filler 5. The second adhesive layer 3b may include a fluorine-based adhesive binder 7.

### Rechargeable Lithium Battery

Another example embodiment includes a rechargeable lithium battery including the separator for a rechargeable lithium battery according to one example embodiment, a positive electrode, and a negative electrode.

The separator for a rechargeable lithium battery is as described above. The separator for a rechargeable lithium battery may be located between the positive electrode and the negative electrode.

For example, the first adhesive layer of the separator may be located close to the negative electrode, and the second adhesive layer may be located close to the positive electrode.

### Positive Electrode

A positive electrode for a rechargeable lithium battery may include a current collector, and a positive electrode active material layer on the current collector. The positive electrode active material layer may include a positive electrode active material, and may further include a binder and/or a conductive material. For example, the positive electrode may further include an additive that can constitute a sacrificial positive electrode.

### Positive Electrode Active Material

The positive electrode active material may include a compound (lithiated intercalation compound) that is capable of intercalating and deintercalating lithium. For example, at least one of a composite oxide of lithium and a metal such as or including at least one of cobalt, manganese, nickel, and combinations thereof, may be used.

The composite oxide may be or include a lithium transition metal composite oxide. Examples of the composite oxide may include at least one of lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O_{2-α}D_{α} (0.90≤a≤1.8, 0≤b≤0.5, 0≤c≤0.5, and 0<α<2); LiₐNi_{1-c}Mn_{b}X_{c}O_{2-α}D_{α} (0.90≤a≤1.8, 0≤b≤0.5, 0≤c≤0.5, and 0<α<2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}dO₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); or LiₐFePO₄ (0.90≤a≤1.8).

In the above Chemical Formulas, A is or includes at least one of Ni, Co, Mn, or a combination thereof, X is or includes at least one of Al, Ni, Co, Mn, Cr, Fe, Mg, Sr, V, a rare earth element or a combination thereof, D is or includes at least one of O, F, S, P, or a combination thereof, G is or includes at least one of Al, Cr, Mn, Fe, Mg, La, Ce, Sr, V, or a combination thereof, and L¹ is or includes at least one of Mn, Al, or a combination thereof.

The positive electrode active material may be or include, for example, a high nickel-based positive electrode active material having a nickel content that is greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity, and can be applied to a high-capacity, high-density rechargeable lithium battery.

An amount of the positive electrode active material may be in a range of about 90 wt % to about 99.5 wt % based on 100 wt % of the positive electrode active material layer. Amounts of each of the binder and the conductive material may independently be in a range of about 0.5 wt % to about 5 wt %, respectively, based on 100 wt % of the positive electrode active material layer.

The binder attaches the positive electrode active material particles to each other, and attaches the positive electrode active material to the current collector. Examples of the binder may include at least one of polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may impart conductivity (e.g., electrical conductivity) to the electrode. Any material that does not cause chemical change (e.g., does not cause an undesirable chemical change in the rechargeable lithium battery), and that conducts electrons, can be used in the battery. Examples of the conductive material may include a carbon-based material such as at least one of natural graphite, artificial graphite, carbon black, acetylene black, ketjen black, a carbon fiber, a carbon nanofiber, and carbon nanotube; a metal-based material containing at least one of copper, nickel, aluminum, silver, and the like, in a form of a metal powder or a metal fiber; a conductive polymer such as a polyphenylene derivative; or a mixture thereof.

Al may be used as the current collector, but the current collector is not limited thereto.

### Negative Electrode

The negative electrode for a rechargeable lithium battery may include a current collector, and a negative electrode active material layer on the current collector. The negative electrode active material layer may include a negative electrode active material, and may further include a binder and/or a conductive material (e.g., an electrically conductive material).

For example, the negative electrode active material layer may include about 90 wt % to about 99 wt % of the negative electrode active material, about 0.5 wt % to about 5 wt % of the binder, and about 0 wt % to about 5 wt % of the conductive material.

### Negative Electrode Active Material

The negative electrode active material may include at least one of a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example, crystalline carbon, amorphous carbon or a combination thereof. The crystalline carbon may be graphite such as non-shaped, sheet-shaped, flake-shaped, sphere-shaped, or fiber-shaped, natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOx (0<x<2), a Si-Q alloy (where Q is or includes at least one of an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include at least one of Sn, SnO₂, a Sn-based alloy, or a combination thereof.

The silicon-carbon composite may be or include a composite of silicon and amorphous carbon. According to an example embodiment, the silicon-carbon composite may be in the form of silicon particles, and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be present between the primary silicon particles, and, for example, the primary silicon particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles, and an amorphous carbon coating layer on a surface of the core.

The Si-based negative electrode active material or the Sn-based negative electrode active material may be used in combination with a carbon-based negative electrode active material.

The binder may attach the negative electrode active material particles to each other, and attach the negative electrode active material to the current collector. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be or include at least one of a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include at least one of Na, K, or Li.

The dry binder may be or include a polymer material that is capable of being fibrous. For example, the dry binder may be or include at least one of polytetrafluoroethylene, polyvinylidene fluoride, a polyvinylidene fluoride-hexafluoropropylene copolymer, polyethylene oxide, or a combination thereof.

The conductive material may impart conductivity (e.g., electrical conductivity) to the electrode. Any material that does not cause chemical change (e.g., does not cause an undesirable chemical change in the rechargeable lithium battery), and that conducts electrons, can be used in the battery. Non-limiting examples thereof may include a carbon-based material such as at least one of natural graphite, artificial graphite, carbon black, acetylene black, ketjen black, a carbon fiber, a carbon nanofiber, and a carbon nanotube; a metal-based material including at least one of copper, nickel, aluminum, silver, and the like, in a form of a metal powder or a metal fiber; a conductive polymer such as a polyphenylene derivative; or a mixture thereof.

The negative current collector may include at least one of a copper foil, a nickel foil, a stainless steel foil, a titanium foil, a nickel foam, a copper foam, a polymer substrate coated with a conductive metal, or a combination thereof.

The rechargeable lithium battery may further include an electrolyte solution.

### Electrolyte Solution

The electrolyte solution for a rechargeable lithium battery may include a non-aqueous organic solvent and a lithium salt.

The non-aqueous organic solvent may constitute a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like.

The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like.

The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include ethanol, isopropyl alcohol, and the like. The aprotic solvent may include at least one of nitriles such as R—CN (wherein R is a C2 to C20 linear, branched, or cyclic hydrocarbon group, a double bond, an aromatic ring, or an ether bond, and the like); amides such as dimethylformamide; dioxolanes such as 1,3-dioxolane, 1,4-dioxolane, and the like; sulfolanes, and the like.

The non-aqueous organic solvents may be used alone, or in combination of two or more solvents.

In addition, when using a carbonate-based solvent, a cyclic carbonate and a chain carbonate may be mixed together, and the cyclic carbonate and the chain carbonate may be mixed in a volume ratio in a range of about 1:1 to about 1:9.

The lithium salt dissolved in the organic solvent supplies lithium ions in a battery, enables an operation of a rechargeable lithium battery, and improves transportation of the lithium ions between positive and negative electrodes. Examples of the lithium salt include at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (wherein x and y are integers in a range of 1 to 20), lithium trifluoromethane sulfonate, lithium tetrafluoroethanesulfonate, lithium difluorobis(oxalato)phosphate (LiDFOB), and lithium bis(oxalato) borate (LiBOB).

The rechargeable lithium battery may be classified into cylindrical, prismatic, pouch, or coin-type batteries, and the like depending on their shape.

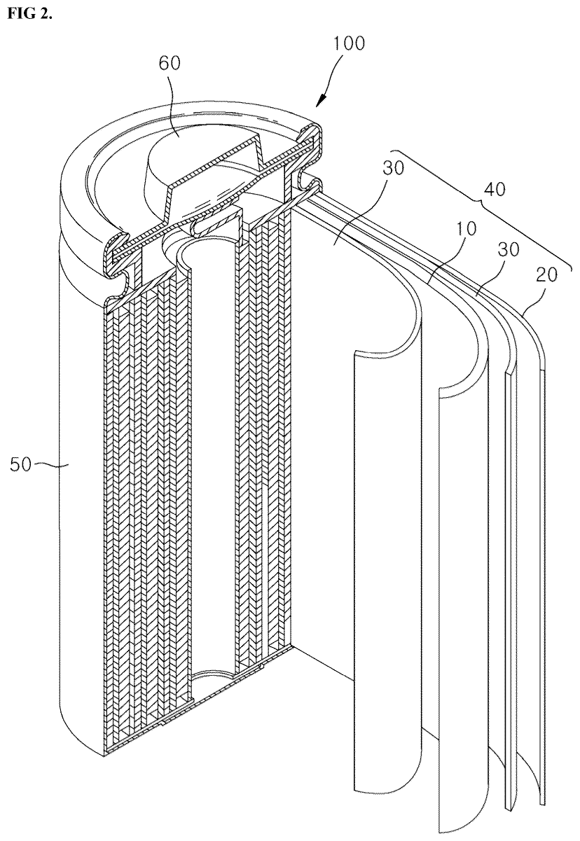

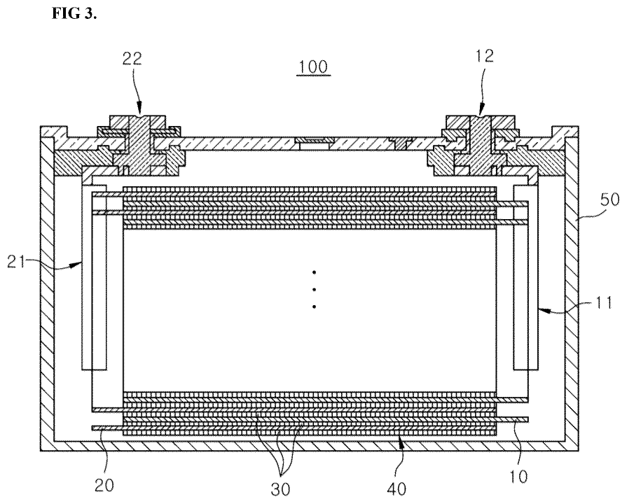

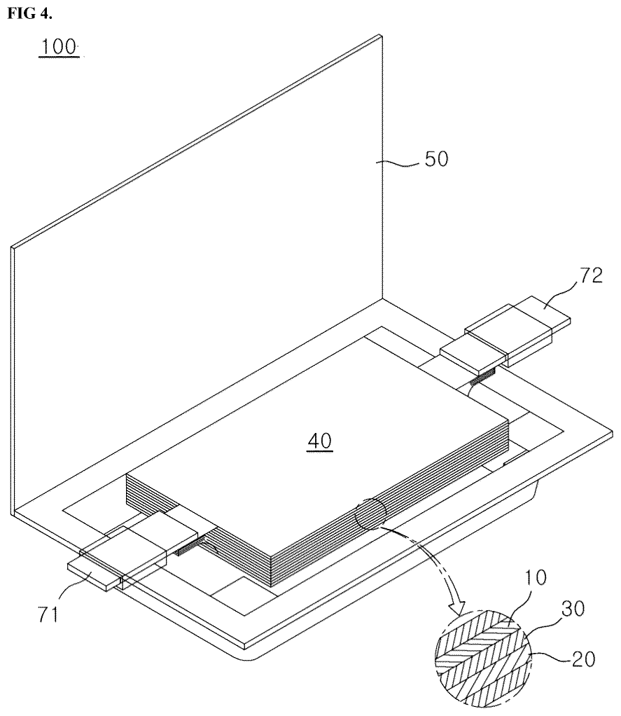

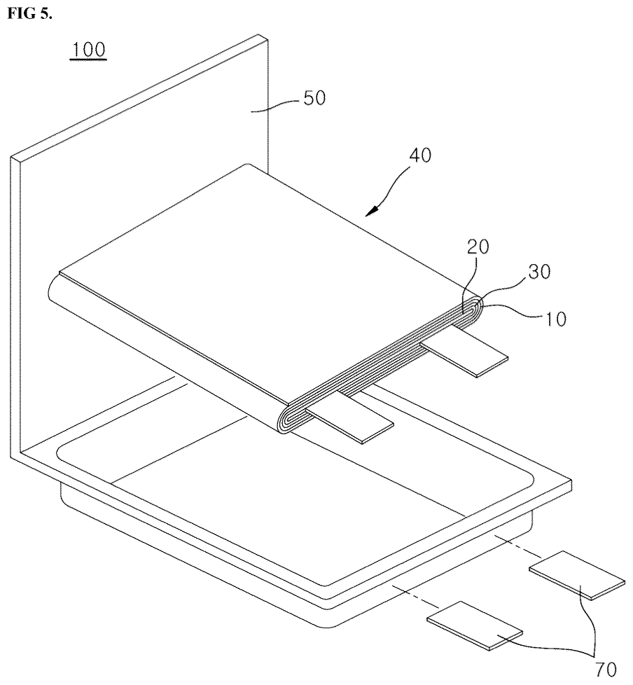

FIG. 2 to FIG. 5 are schematic views illustrating a rechargeable lithium battery according to an example embodiment. FIG. 2 shows a cylindrical battery, FIG. 3 shows a prismatic battery, and FIG. 4 and FIG. 5 show pouch-type batteries. Referring to FIG. 2 to FIG. 5, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution (not shown). The rechargeable lithium battery 100 may include a sealing member 60 sealing the case 50, as shown in FIG. 2. In FIG. 3, the rechargeable lithium battery 100 may include a positive lead tab 11, a positive terminal 12 connected to the positive lead tab 11, a negative lead tab 21, and a negative terminal 22 connected to the negative lead tab 21. As shown in FIG. 4 and FIG. 5, the rechargeable lithium battery 100 may include an electrode tab 70 illustrated in FIG. 5, or, for example, a positive electrode tab 71 and a negative electrode tab 72 illustrated in FIG. 4, the electrode tabs 70/71/72 forming an electric path for inducing the current formed in the electrode assembly 40 to the outside of the battery 100.

The rechargeable lithium battery according to an example embodiment may be applicable to, e.g., automobiles, mobile phones, and/or various types of electric devices, as non-limiting examples.

Hereinafter, examples and comparative examples of the present disclosure are described. However, the following examples are only examples of the present disclosure, and the present disclosure is not limited to the following examples.

### Preparation Example 1

To a 3 L four-necked separable flask equipped with a stirrer, a thermometer, and a condenser, distilled water (1249.72 g), a 20% lithium hydroxide aqueous solution (203.69 g), acrylic acid (AA, 0.3 mol), 2-hydroxyethyl methacrylate (HEMA, 0.10 mol), 2-acrylamido-2-methylpropanesulfonic acid (AMPS, 0.6 mol), and ammonium persulfate (0.2 g, 0.001 mol) were added, and then an operation of reducing an internal pressure to 10 mmHg with a diaphragm pump and returning the internal pressure to normal pressure with nitrogen was repeated three times. The reaction was performed for 12 hours while controlling heating so that the temperature of a reaction solution was stabilized between 65° C. and 70° C. After cooling to room temperature, about 10 mL of the reaction solution was taken and a non-volatile (NV) component content was measured, which was 9.8 wt % (theoretical value: 10 wt %). In addition, in the resulting poly(acrylic acid-co-2-hydroxyethyl methacrylate-co-2-acrylamido-2-methylpropanesulfonic acid) lithium salt, a molar ratio of a first structural unit derived from lithium acrylate, a second structural unit derived from 2-hydroxyethyl methacrylate, and a third structural unit derived from 2-acrylamido-2-methylpropanesulfonic acid lithium salt was 30:10:60.

### Preparation Example 2

In Preparation Example 1, the content of each monomer was changed to prepare poly(lithium acrylate-co-2-hydroxyethyl methacrylate-co-2-acrylamido-2-methylpropanesulfonic acid lithium salt). A molar ratio of lithium acrylate, 2-hydroxyethyl methacrylate, and 2-acrylamido-2-methylpropanesulfonic acid lithium salt was 40:10:50. About 10 mL of a reaction solution (reaction product) was taken and a non-volatile component content was measured, which was 9.0 wt % (theoretical value: 10 wt %).

### Preparation Example 3

In Preparation Example 1, the content of each monomer was changed to prepare poly(lithium acrylate-co-2-hydroxyethyl methacrylate-co-2-acrylamido-2-methylpropanesulfonic acid lithium salt). A molar ratio of lithium acrylate, 2-hydroxyethyl methacrylate, and 2-acrylamido-2-methylpropanesulfonic acid lithium salt was 65:5:30. About 10 mL of a reaction solution (reaction product) was taken and a non-volatile component content was measured, which was 9.0 wt % (theoretical value: 10 wt %).

### Preparation Example 4

In Preparation Example 1, the content of each monomer was changed to prepare poly(lithium acrylate-co-2-hydroxyethyl methacrylate-co-2-acrylamido-2-methylpropanesulfonic acid lithium salt). A molar ratio of lithium acrylate, 2-hydroxyethyl methacrylate, and 2-acrylamido-2-methylpropanesulfonic acid lithium salt was 40:5:55. About 10 mL of a reaction solution (reaction product) was taken and a non-volatile component content was measured, which was 9.0 wt % (theoretical value: 10 wt %).

### Preparation Example 5

An acrylic copolymer was prepared in the same manner as in Preparation Example 1, except that 2-hydroxyethyl methacrylate and 2-acrylamido-2-methylpropanesulfonic acid were used and acrylic acid was not used. A molar ratio of 2-hydroxyethyl methacrylate:2-acrylamido-2-methylpropanesulfonic acid lithium salt was 74:26. A non-volatile component content of the reaction solution was 9.0 wt % (theoretical value: 10 wt %).

### Preparation Example 6

An acrylic copolymer was prepared in the same manner as in Preparation Example 1, except that acrylic acid and 2-acrylamido-2-methylpropanesulfonic acid were used, and 2-hydroxyethyl methacrylate was not used. A molar ratio of acrylic acid:2-acrylamido-2-methylpropanesulfonic acid lithium salt was 74:26. A non-volatile component content of the reaction solution was 9.0 wt % (theoretical value: 10 wt %).

### Preparation Example 7

An acrylic copolymer was prepared in the same manner as in Preparation Example 1, except that acrylic acid and 2-hydroxyethyl methacrylate were used and 2-acrylamido-2-methylpropanesulfonic acid was not used. A molar ratio of lithium acrylate:2-hydroxyethyl methacrylate was 42:58. A non-volatile component content of the reaction solution was 9.0 wt % (theoretical value: 10 wt %).

### Example 1

(1) Boehmite (particle size D50: 150 nm, KB-01S of DAEJOO·KC CO., LTD, cubic) as a first filler and ZIF-8 and an ZIF-8 (particle size D50: 120 nm), which is an MOF, as a second filler were mixed in a weight ratio of 90:10 based on a total of 100 parts by weight to prepare a mixture.

The (meth)acrylic binder (10 wt % in distilled water) prepared in Preparation Example 1 and the mixture prepared above were mixed at a (meth)acrylic binder:filler mass ratio=1:20, input into a water solvent, then milled and dispersed using a bead mill at 25° C. for 30 minutes to prepare a dispersion.

Trimethylolpropane tris(2-methyl-1-aziridine propionate) (trifunctional aziridine-based crosslinking agent) as an aziridine-based crosslinking agent was input into the dispersion, and water was added so that the total solid content became 20 wt % to prepare a composition for forming a first coating layer and a composition for a second coating layer. At this time, the aziridine-based crosslinking agent was included in an amount of 10 parts by weight based on 100 parts by weight of the (meth)acrylic binder.
(2) The first coating layer composition prepared as described above was applied on a first surface of a polyethylene film (thickness: 5.5 μm, CZMZ, air permeability: 110 sec/100 cc, puncture strength: 340 kgf) as a porous substrate using a die coating method, and the second coating layer composition prepared as described above was applied on a second surface using a die coating method, and dried and aged in an oven at 70° C. for 16 hours to form a first coating layer and a second coating layer.
(3) A composition including cross-linked polymethyl methacrylate (Tg: 50° C.) was applied on the first coating layer manufactured above using a die coating method, and dried and aged to form a first adhesive layer.
(4) A mixture of a binder having an IPN structure of a polyvinylidene fluoride crosslinked polymer and an acrylate crosslinked polymer and a fluorine-based homopolymer (having a carbonyl (C═O) functional group) as an aqueous adhesive binder was diluted to a concentration of 2 wt % solids to prepare a composition for a second adhesive layer.
(5) The composition for the second adhesive layer manufactured as described above was applied on the second coating layer manufactured as described above using a die coating method, dried and aged to form a second adhesive layer, thereby manufacturing a separator having the first coating layer (thickness: 0.7 μm), the first adhesive layer (thickness: 0.5 μm), the second coating layer (thickness: 0.7 μm), and the second adhesive layer (thickness: 0.5 μm).

### Example 2

A separator was manufactured in the same manner as in Example 1, except that a weight ratio between the fillers was changed to 60:40.

### Examples 3 to 5

Separators were manufactured in the same manner as in Example 1, except that the binder type was changed as shown in Table 1 below and used instead of the binder of Preparation Example 1.

### Comparative Example 1

A separator was manufactured in the same manner as in Example 1, except that crosslinked PMMA was used as a second adhesive binder without using the aziridine-based crosslinking agent.

### Comparative Example 2

A separator was manufactured in the same manner as in Example 1, except that polyvinyl alcohol (PVA) was used instead of the binder of Preparation Example 1.

### Comparative Example 3

A separator was manufactured in the same manner as in Example 1, except that the weight ratio of the fillers was changed and the second adhesive binder was used as the first adhesive binder.

### Comparative Examples 4 to 6

Separators were manufactured in the same manner as in Example 1, except that the binder type was changed as shown in Table 1 below and used instead of the binder in Example 1 of Preparation Example 1.

### Comparative Example 7

A separator was manufactured in the same manner as in Example 1, except that in ethylene glycol diglycidyl ether (epoxy-based crosslinking agent) was used instead of the aziridine-based crosslinking agent and the second filler was not used.

### Comparative Example 8

A separator was manufactured in the same manner as in Example 1, except that CARBODILITE V-50 (Nisshinbo Chemical) was used as a carbodiimide (CDI)-based crosslinking agent instead of the aziridine-based crosslinking agent.

### Dry Thermal Shrinkage Rate (Units: %)

The separators for rechargeable lithium batteries of the examples and comparative examples were cut into a size of 8 cm×8 cm to prepare samples. After drawing a 5 cm×5 cm square on the surface of the sample, the sample was placed between paper or alumina powder, allowed to stand in an oven at 150° C. for 1 hour, and taken out, the dimensions of the sides of the drawn square were measured, and the shrinkage rate in each of the machine direction (MD) and transverse direction (TD) were calculated. The shrinkage rate is calculated according to Mathematical Formula 1 below.

$$Shrinkage rate = ( L 0 - L 1 ) / L 0 \times 100. \qquad Mathematical Formula 1$$

L0 is the initial length of the separator, and L1 is the length of the separator after being allowed to stand at 150° C. for 1 hour.

### Thermal Shrinkage Rate in Electrolyte (Wet Thermal Shrinkage Rate, Units: %)

### Manufacture of Negative Electrode:

97 wt % of graphite particles with an average particle size of 25 μm, 1.5 wt % of a styrene-butadiene rubber (SBR) binder, and 1.5 wt % of carboxymethyl cellulose (CMC) were mixed to form a mixture, and the mixture was input into distilled water and stirred for 60 minutes using a mechanical stirrer to prepare a negative electrode active material slurry. The slurry was applied onto a 10 μm-thick copper current collector using a doctor blade, dried in a hot air dryer at 100° C. for 0.5 hour, dried again under vacuum at 120° C. for 4 hours, and then roll-pressed to manufacture a negative electrode.

### Manufacture of Positive Electrode:

97 wt % of LiCoO₂, 1.5 wt % of carbon black powder as a conductive material, and 1.5 wt % of polyvinylidene fluoride (PVdF) were mixed, input into an N-methyl-2-pyrrolidone solvent, and stirred for 30 minutes using a mechanical stirrer to prepare a positive electrode active material slurry. The slurry was applied onto a 20 μm-thick aluminum current collector using a doctor blade, dried in a hot air dryer at 100° C. for 0.5 hour, dried again under vacuum at 120° C. for 4 hours, and then roll-pressed to manufacture a positive electrode.

One sheet of the sample was placed between the positive electrode and the negative electrode to manufacture three sets of positive electrode-sample-negative electrode laminates, which were then placed in a pouch. 3 g of an electrolyte (1.5 M LiPF₆ dissolved in ethylene carbonate, ethyl methyl carbonate, and dimethyl carbonate (volume ratio of 30:50:20 based on the total volume of 100)) was injected to completely saturate the laminate with the electrolyte, and the pouch was sealed and allowed to stand at 25° C. for 12 hours. Then, after being allowed to stand in an oven at 150° C. for 1 hour, the sample was taken out and cooled, and then the dimensions of the sides of the sample were measured to calculate a shrinkage rate. The shrinkage rate may be calculated according to the above Mathematical Formula 1.

### Membrane Resistance (Units: Ω)

The membrane resistance was evaluated as electrochemical impedance spectroscopy (EIS) resistance. The separators manufactured in the examples and comparative examples were impregnated with an electrolyte (1.5 M LiPF₆ dissolved in a mixed solvent of ethylene carbonate, ethyl methyl carbonate, and dimethyl carbonate (volume ratio of 2/1/7)), fitted onto an aluminum foil electrode with a lead tab, and sealed in an aluminum pack to manufacture a test cell, and the resistance (Q) of this test cell was measured at 20° C. by the AC impedance method (measurement frequency 100 kHz).

### Adhesion to Positive Electrode (Units: Gf/Mm)

The separator was attached to a positive electrode (manufactured in the same manner as in the above manufacture of the battery) so that the second coating layer of the separator faces the positive electrode, the resulting assembly was inserted into a pouch, an electrolyte (1.3 M LiPF₆ in a 3/5/2 (volume ratio) mixed solvent of ethylene carbonate (EC)/ethyl methyl carbonate (EMC)/diethyl carbonate (DEC)) was injected, and the pouch was allowed to stand for 12 hours, pressed under conditions of a pressure in a range of 10 kgf/cm² to 20 kgf/cm², a temperature in a range of 70° C. to 90° C., and a duration in a range of 5 seconds to 20 seconds, and then disassembled. After taking the separator and the positive electrode out of the pouch, the positive electrode and separator were spread out 180°, and the force required to detach the positive electrode from the separator was measured using a tension meter (Tinius Olsen, HT400).

### Adhesion to Negative Electrode (Units: Gf/Mm)

The separator was attached to a negative electrode (manufactured in the same manner as in the above manufacture of the battery) so that the first coating layer of the separator faces the negative electrode, the resulting assembly was inserted into a pouch, an electrolyte (1.3 M LiPF₆ in a 3/5/2 (volume ratio) mixed solvent of EC/EMC/DEC) was injected, and the pouch was allowed to stand for 12 hours, pressed under conditions of a pressure in a range of 10 kgf/cm² to 20 kgf/cm², a temperature of 70° C. to 90° C., and a duration in a range of 5 seconds to 20 seconds, and then disassembled. After taking the separator and the negative electrode out of the pouch, the negative electrode and separator were spread out 180°, and the force required to detach the negative electrode from the separator was measured using a tension meter (Tinius Olsen, HT400). to detach.

### Rate Characteristics (Units: %)

Coin full cells were manufactured, the 1C, 3C, and 5C discharge capacities were measured, and the 5C capacity of Example 1 was set as 100% for relative comparison.

TABLE 1

| | | Examples | | | | |
|---|---|---|---|---|---|---|
| | | 1 | 2 | 3 | 4 | 5 |
| Binder | AA | 30 | 30 | 40 | 65 | 40 |
| | HEMA | 10 | 10 | 10 | 5 | 5 |
| | AMPS | 60 | 60 | 50 | 30 | 55 |
| Filler weight ratio | | 90:10 | 60:40 | 90:10 | 90:10 | 90:10 |
| Crosslinking agent | | Aziridine | Aziridine | Aziridine | Aziridine | Aziridine |
| First adhesive layer | | Acryl | Acryl | Acryl | Acryl | Acryl |
| Second adhesive layer | | PVDF | PVDF | PVDF | PVDF | PVDF |
| Dry thermal | MD | 4 | 3 | 4 | 3 | 4 |
| shrinkage rate | TD | 3 | 3 | 4 | 3 | 3 |
| Wet thermal | MD | 7 | 9 | 8 | 7 | 8 |
| shrinkage rate | TD | 7 | 9 | 9 | 7 | 7 |
| Adhesion | Positive | 1.09 | 1.11 | 1.06 | 1.08 | 1.09 |
| | electrode | | | | | |
| | Negative | 0.64 | 0.63 | 0.64 | 0.66 | 0.66 |
| | electrode | | | | | |
| Rate | 5 C | 100 | 105 | 101 | 99 | 99 |
| characteristics | discharge | | | | | |

| | | | | | |
|---|---|---|---|---|---|
| Membrane resistance | 0.62 | 0.59 | 0.61 | 0.63 | 0.62 |

TABLE 2

| | | Comparative Examples | | | | | | | |
|---|---|---|---|---|---|---|---|---|---|
| | | 1 | 2 | 3 | 4 | 5 | 6 | 7 | 8 |
| Binder | AA | 30 | — | 30 | 0 | 74 | 42 | 30 | 30 |
| | HEMA | 10 | — | 10 | 74 | 0 | 58 | 10 | 10 |
| | AMPS | 60 | — | 60 | 26 | 26 | 0 | 60 | 60 |
| Filler weight ratio | | 90:10 | 90:10 | 10:90 | 90:10 | 90:10 | 90:10 | 100:0 | 90:10 |
| Crosslinking agent | | 0 | Aziridine | Aziridine | Aziridine | Aziridine | Aziridine | Epoxy | Carbodiimide |
| First adhesive layer | | Acryl | Acryl | PVDF | Acryl | Acryl | Acryl | Acryl | Acryl |
| Second adhesive layer | | Acryl | PVDF | PVDF | PVDF | PVDF | PVDF | PVDF | PVDF |
| Dry | MD | 5 | 12 | 31 | 15 | 15 | 15 | 4 | 4 |
| thermal | TD | 4 | 12 | 32 | 15 | 14 | 15 | 4 | 4 |
| shrinkage | | | | | | | | | |
| rate | | | | | | | | | |
| Wet | MD | 48 | 45 | 58 | 46 | 45 | 46 | 48 | 47 |
| thermal | TD | 46 | 45 | 58 | 46 | 45 | 46 | 47 | 46 |
| shrinkage | | | | | | | | | |
| rate | | | | | | | | | |
| Adhesion | Positive | 0.58 | 1.06 | 1.07 | 1.02 | 1.06 | 1.08 | 1.07 | 1.07 |
| | electrode | | | | | | | | |
| | Negative | 0.65 | 0.64 | 0.28 | 0.62 | 0.65 | 0.66 | 0.64 | 0.66 |
| | electrode | | | | | | | | |
| Rate | 5 C | 90 | 72 | 89 | 96 | 71 | 96 | 74 | 96 |
| characteristics | discharge | | | | | | | | |

| | | | | | | | | |
|---|---|---|---|---|---|---|---|---|
| Membrane resistance | 0.73 | 0.91 | 0.76 | 0.66 | 0.9 | 0.65 | 0.88 | 0.64 |

As shown in Table 1 above, the separators for rechargeable lithium batteries of the examples can provide a low thermal shrinkage rate, high rate characteristics during charging and discharging, low membrane resistance, and high adhesion to the electrode plate, thereby increasing battery reliability.

A separator for a rechargeable battery according to one example embodiment can improve the capacity, safety, and lifespan of a battery by providing a low thermal shrinkage rate, high rate characteristics during charging and discharging, low membrane resistance, and high adhesion to an electrode plate.

Although the example embodiments of the present disclosure have been described above, the present disclosure is not limited thereto, and various modifications may be made within the scope of the claims, the detailed description of the disclosure, and the attached drawings, which also fall within the scope of the present disclosure.

What is claimed is:

1. A separator for a rechargeable battery, the separator comprising:
a porous substrate;
a first coating layer and a first adhesive layer located on a first surface of the porous substrate; and
a second coating layer and a second adhesive layer located on a second surface of the porous substrate,
wherein each of the first coating layer and the second coating layer includes a crosslinked product of a binder and a crosslinking agent, and a filler,
the binder includes a (meth)acrylic binder including a first structural unit derived from (meth)acrylic acid, (meth)acrylate, or a salt thereof, a second structural unit derived from hydroxyalkyl (meth)acrylate, and a third structural unit derived from (meth)acrylamido sulfonic acid or a salt thereof, and the crosslinking agent includes an aziridine-based crosslinking agent,
the filler includes a mixture of a first filler and a second filler, wherein the first filler is an inorganic filler and the second filler is a metal-organic framework structure,
the first adhesive layer includes a (meth)acrylic based adhesive binder, and
the second adhesive layer includes a fluorine-based adhesive binder having a carbonyl group (C═O).

2. The separator of claim 1, wherein the (meth)acrylic binder comprises a salt-based binder.

3. The separator of claim 1, wherein the first filler and the second filler are included in a weight ratio in a range of about 50:50 to about 95:5 based on 100 parts by weight of the mixture.

4. The separator of claim 1, wherein the first filler has an average particle size D50 in a range of about 100 nm to about 200 nm.

5. The separator of claim 1, wherein the second filler comprises a zinc or cobalt ion and an imidazole-based compound linked by a coordinate bond.

6. The separator of claim 1, wherein the second filler has an average particle size D50 in a range of about 100 nm to about 200 nm.

7. The separator of claim 1, wherein the (meth)acrylic binder and the mixture are included in a mass ratio in a range of about 1:10 to about 1:40.

8. The separator of claim 1, wherein the aziridine-based crosslinking agent comprises one or more of N,N′-toluene-2,4-bis(1-aziridine carboxamide), N,N′-(methylenedi-p-phenylene)bis(aziridine-1-carboxamide), triethylenemelamine, 1,1-isophthaloyl bis(2-methylaziridine), tris(1-aziridinyl)phosphine oxide, N,N-hexamethylene-bis(aziridine carboxamide), trimethylolpropane tris(2-methyl-1-aziridine propionate), trimethylolpropane tris(beta-N-aziridinyl)propionate, and pentaerythritol tris(3-(1-aziridinyl)propionate).

9. The separator of claim 1, wherein the crosslinking agent is included in an amount in a range of about 5 parts by weight to about 50 parts by weight based on 100 parts by weight of the (meth)acrylic binder.

10. The separator of claim 1, wherein the first structural unit is represented by at least one of the following Chemical Formula 1, Chemical Formula 2, Chemical Formula 3, and a combination thereof: 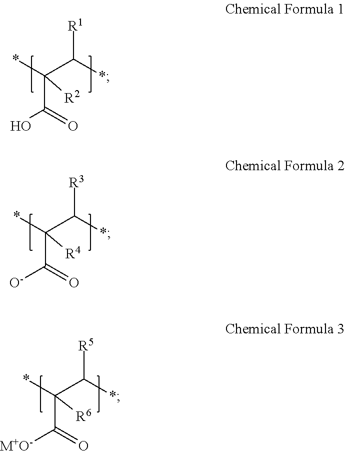
the second structural unit is represented by Chemical Formula 4: 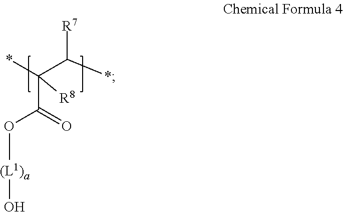
and
the third structural unit is represented by at least one of Chemical Formula 5, Chemical Formula 6, Chemical Formula 7, and a combination thereof: 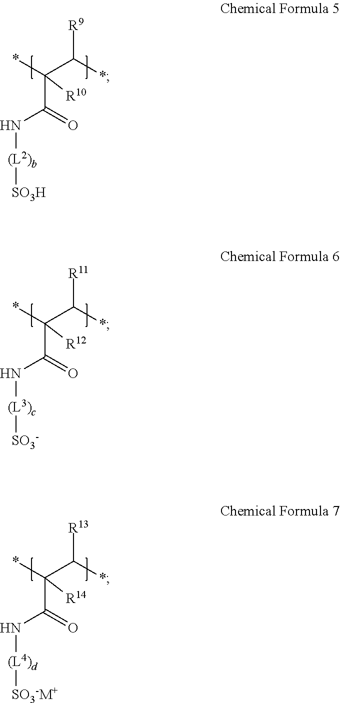
wherein R¹ to R¹⁴ each independently comprises hydrogen or a C1 to C10 alkyl group,
L¹ to L⁴ each independently comprises a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group,
a, b, c, and d are each independently an integer in a range from 0 to 2, and
M comprises an alkali metal.

11. The separator of claim 1, wherein the (meth)acrylic binder is represented by Chemical Formula 8: 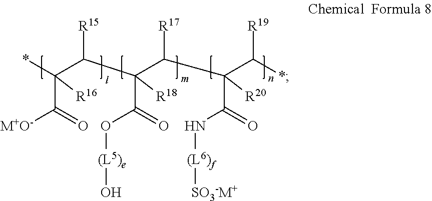
wherein:
R¹⁵ to R²⁰ each independently comprises hydrogen or a C1 to C10 alkyl group,
L⁵ and L⁶ each independently comprises a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group,
M comprises an alkali metal,
e and f are each independently an integer in a range from 0 to 2, and
l, m, and n are molar ratios of each unit, and l+m+n=1.

12. The separator of claim 1, wherein:
the first structural unit is included in an amount in a range of about 20 mol % to about 75 mol %;
the second structural unit is included in an amount in a range of about 1 mol % to about 20 mol %; and
the third structural unit is included in an amount in a range of about 20 mol % to about 75 mol %, based on 100 mol % of the (meth)acrylic binder.

13. The separator of claim 1, wherein a sum of the content of the first structural unit, the second structural unit, and the third structural unit is about 95 mol % or more based on 100 mol % of the (meth)acrylic binder.

14. The separator of claim 1, wherein the (meth)acrylic based adhesive binder has a glass transition temperature in a range of about 50° C. to about 110° C.

15. The separator of claim 1, wherein the fluorine-based adhesive binder comprises a fluorine-based adhesive binder having a carbonyl group (C═O) and a hydroxyl group (OH).

16. A rechargeable battery comprising:
a positive electrode;
a negative electrode; and
the separator of claim 1 between the positive electrode and the negative electrode.
